(19) United States
(12) Patent Application Publication
(10) Pub. No.: US 2012/0164502 A1
(43) Pub. Date: Jun. 28, 2012

(54) GALVANIC ELEMENT AND SEPARATOR HAVING IMPROVED SAFETY PROPERTIES

(75) Inventors: Konrad Holl, Aalen-Dewangen (DE); Markus Pompetzki, Ellwangen (DE); Markus Kohlberger, Ellwangen (DE); Alfons Joas, Tannhausen (DE); Kemal Akca, Ellwangen (DE); Horst Wagner, Rosenberg (DE); Peter Haug, Ellwangen (DE); Arno Perner, Ellwangen (DE)

(73) Assignees: VOLKSWAGEN VARTA Microbattery Forschungsgesellschaft mbH & Co. KG, Ellwangen (DE); VARTA Microbattery GmbH, Ellwangen (DE)

(21) Appl. No.: 13/386,921

(22) PCT Filed: Jul. 26, 2010
(86) PCT No.: PCT/EP2010/060777

§ 371 Date: Mar. 13, 2012

(30) Foreign Application Priority Data
Jul. 27, 2009 (DE) 10 2009 035 759.9

(51) Int. Cl. H01M 2/16; H01M 4/38; H01M 4/00; H01M 2/18; H01M 10/04

(52) U.S. Cl. 429/94; 429/246; 429/144; 429/162; 429/231.95

(57) ABSTRACT

A galvanic element has a positive electrode, a negative electrode and a separator lying in between, wherein the separator consists at least partially of a polymer of which the melting and/or softening temperature is >200° C. A multi-layer separator for galvanic elements, in particular for lithium-ion batteries, includes at least one layer of the polymer with a melting and/or softening temperature >200° C.

### RELATED APPLICATIONS

This is a §371 of International Application No. PCT/EP2010/060777, with an international filing date of Jul. 26, 2010 (WO 2011/012567 A1, published Feb. 3, 2011), which is based on German Patent Application No. 10 2009 035 759.9, filed Jul. 27, 2009, the subject matter of which is incorporated by reference.

### TECHNICAL FIELD

This disclosure relates to a galvanic element which comprises a separator having improved safety properties. In addition, the disclosure also relates to a separator having the improved safety properties itself.

### BACKGROUND

An electrical separator is a membrane which is used especially in batteries and storage batteries to separate electrodes of opposed polarity from one another. The separator is generally produced from an electrically insulating material, but is permeable to ions and has a high mechanical strength and good chemical resistance to solvents and other chemicals that are used in batteries. It is also of advantage if a separator has a certain elasticity, since it is often also exposed to mechanical loads during charging and discharging processes, in particular in lithium-ion and lithium-polymer batteries.

Commercially available separators mostly consist of porous organic polymer films or of nonwoven fabrics, for example, nonwovens of glass or ceramic materials. Thus, for example, porous films of polypropylene or of a polypropylene/polyethylene/polypropylene composite can be used as separators.

Primary or secondary lithium systems are very often used nowadays in batteries. In comparison with classical nickel-cadmium batteries or nickel-metal hydride batteries, lithium batteries are distinguished by numerous advantages. To be emphasized in particular are the very high specific energy density and the fact that lithium batteries generally have an only very low self-discharging rate and virtually no memory effect. However, it is disadvantageous that lithium batteries generally always contain a combustible electrolyte and often also combustible electrode materials such as graphite. Metallic lithium additionally reacts very strongly to water. Therefore, instances where lithium batteries are overcharged or damaged may lead to fires or even explosions.

It is therefore necessary to provide lithium batteries with safety mechanisms so that in the event of the battery being damaged or overcharged, and heated as a consequence, the circuit in the battery is interrupted. This may take place, for example, by special separators, for example, polyolefin separators of polypropylene and polyethylene already mentioned above. From a specific temperature known as the “shutdown temperature,” the polyethylene melts and the pores of the separator are closed. The circuit is thereby irreversibly interrupted, and further uncontrolled discharging of the cell cannot take place. However, a disadvantage of separators of polyolefins is their limited thermal stability since, when the battery heats up further, the polypropylene also melts. As a consequence, melting of the entire separator (known as “meltdown”) may occur, and with it an internal short-circuit over a large area.

Ceramic-based separators, for example, the already mentioned separators of ceramic nonwoven fabrics or ceramic woven fabrics, are protected from meltdown effects. However, these separators in turn do not have a shutdown effect which for many battery customers is an indispensable safety feature.

It could therefore be helpful to provide batteries having improved safety properties and batteries with separators improved with regard to their safety properties.

### SUMMARY

We provide a galvanic element including a positive electrode, a negative electrode and a separator consisting at least partially of a polymer of which melting and/or softening temperature is >200° C. in between the positive and negative electrodes.

We also provide a multi-layer separator for galvanic elements including at least one layer of a polymer with a melting and/or softening temperature >200° C. and at least one further layer of a polymer with a melting and/or softening temperature <200° C.

### BRIEF DESCRIPTION OF THE DRAWINGS

FIG. 1 is a graph showing temperature and voltage of a conventional cell as a function of time.

FIG. 2 is a graph showing temperature and voltage of one of our cells as a function of time.

### DETAILED DESCRIPTION

We provide a galvanic element comprising a positive electrode, a negative electrode and a separator lying in between.

A galvanic element is particularly distinguished by the fact that the separator consists at least partially of a polymer of which the melting and/or softening temperature lies above 200° C. A separator with such a polymer has a much greater thermal stability than known organic separators. Thus, for example, the polyolefin separators mentioned at the beginning all generally melt already at temperatures well below 200° C. The melting range of polypropylene is generally from 160° C. to 165° C., that of polyethylene has a maximum of 145° C. (in the case of high-density polyethylene).

As is known, the melting temperature refers to the temperature at which a substance melts, that is to say goes over from the solid state to the liquid state of aggregation. In the case of polymers, this temperature cannot always be determined well. Some polymers decompose before they melt. In the case of these polymers, the aforementioned softening temperature may be used instead as a characteristic value. The softening temperature (also known as the “glass transition” temperature T_{G}) is the temperature at which a polymer has the greatest change in deformability. Other polymers do not have a definite melting point, but melt within a temperature range. In the case of these polymers, the lower limit of this range shall be used as the melting temperature.

Further preferably, the galvanic element comprises a separator which consists at least partially of a polymer of which the melting and/or softening temperature lies between 200° C. and 400° C. Within this range, a melting and/or softening temperature of between 300° C. and 400° C. is further preferred.

In principle, a number of polymers come into consideration as a polymer with the melting and/or softening temperature above 200° C., but polyether ketones (PEK) have proven to be particularly suitable, most particularly preferably polyether ether ketones (PEEK).

As is known, polyether ketones are high-temperature resistant thermoplastics. Ketone PEEK is one of the most well known and important of these. The melting temperature of PEEK is about 335° C. to 345° C. There are various derivatives (for example, PEEEK, PEEKEK and PEKK) which have slightly different melting points (for example, PEKK about 391° C. or PEEEK about 324° C.). Polyether ketones are resistant to almost all organic and inorganic chemicals. They are sensitive to UV radiation and strong acidic and oxidizing conditions such as are not generally encountered in batteries, however.

High-temperature stable polymers such as polyether ketones are distinguished by the fact that, when they are heated up, they exhibit no or only very little shrinkage. The shrinking of separators when subjected to heating has often led to problems in the case of known galvanic elements. For instance, it has been possible to observe in cells internal short-circuits caused by the separator of an electrode-separator laminate drawing back when it is subjected to heating, and thus allowing direct contacts between the electrodes. In our galvanic elements, problems such as this only occur very rarely, preferably no longer at all.

Preferably, the separator in an element when subjected to heating from room temperature to 200° C. has a maximum shrinkage value of 5%. This applies in particular to separators of PEEK. The maximum shrinkage value refers in this case both to the length and width of the separator. Under the specified heating, the separator should not shrink by more than 5% either in the longitudinal direction or perpendicularly thereto. The shrinkage value can be determined by heating at least three test pieces each 10 cm in length (and each of the same thickness, preferably in a range between 5 μm and 100 μm) in an oven and exposing them to air at 200° C. for 5 minutes. The changes in length thereby occurring are determined and averaged.

Apart from their high thermal resistance, separators of PEEK in particular are distinguished by outstanding mechanical resistance. Separators in our galvanic elements, in particular those which consist at least partially of PEEK, preferably have a very high puncture resistance of 100 g to 300 g, preferably 150 g to 250 g, in particular about 200 g. These values can be determined by the standard test according to ASTM D3763.

The separator of a galvanic element is preferably a film, that is to say not, for instance, a nonwoven fabric or woven fabric. Such a separator can be classically produced, for example, by extrusion, or it is cast.

Preferred in particular are single-layer films which consist at least partially, preferably completely, of the polymer with the melting and/or softening temperature >200° C.

Also particularly suitable, however, as separators for a galvanic element are multi-layer films which can be produced, for example, by coextrusion, having at least one layer of the polymer with the melting and/or softening point above 200° C. Apart from the at least one layer of the polymer with the melting and/or softening point >200°, these multi-layer films preferably comprise at least one further layer of a further polymer, in particular a comparatively lower melting polymer.

Thus, particularly preferably, the separator may comprise along with the layer of the high-temperature resistant polymer with the melting and/or softening point above 200° C. also one or more layers of a polymer which has a melting and/or softening temperature <200° C., in particular between 100° C. and 200° C.

This polymer with a melting and/or softening temperature <200° C. is particularly preferably a polyolefin, most particularly preferably polyethylene and/or polypropylene.

Such a multi-layer film separator combines the properties of a high-temperature resistant separator such as the ceramic nonwoven fabrics or ceramic woven fabrics mentioned at the beginning with the properties of a simple polyolefin separator. When subjected to heating, a shutdown of the battery can already take place at relatively low temperatures.

The polymer with the melting and/or softening temperature <200° C. melts and thereby closes the pores of the layer of the polymer at a melting and/or softening temperature >200° C. This layer in turn does not itself melt, however, so that a meltdown, that is to say the complete fusing together of the separator, can be prevented.

The separator has a permeability to ions, in particular to lithium ions. Particularly preferably, it has a porosity of between 15 and 85% by volume, preferably of between 35 and 60% by volume. The porosity thereby represents the ratio of the void volume to the overall volume of the polymer layer, and therefore serves as a classifying measure of the voids that are actually present. The porosity may be determined, for example, by comparing the relative density of a film separator with the relative density of a non-porous film that has been produced under the same conditions as the film separator, apart from special measures for producing the pores.

The above statements concerning porosity preferably apply to both single-layer and multi-layer film separators and in the latter case both to layers of the polymer with the melting and/or softening temperature <200° C. and to layers of the polymer with the melting and/or softening temperature >200° C.

Such a porous separator can be produced, for example, by film casting or extrusion (or in the case of a multi-layer film separator also by coextrusion of a number of polymers) and subsequent stretching, in particular in a tensile stretching machine. Alternatively, for example, a polymer may be mixed with a mineral oil and extruded. During the subsequent removal of the mineral oil, the pores are then exposed. The two techniques may also be readily combined. In principle, however, such procedures are part of the prior art and therefore do not require further explanation.

A further feature by which the separator can be characterized, at least in particularly preferred galvanic elements, is the permeability of the separator. We found that particularly suitable separators, in particular those of PEEK or having at least one layer of PEEK, should have a Gurley value of between 90 and 600 sec/100 cm³ of air. The Gurley value specifies the time in which 100 cm³ of air flows through an area of the separator 6.4 cm² in size with a pressure differential of 0.188 psi (0.00124106 bar). Determination of the Gurley value is generally performed in a densometer.

The single- or multi-layer separator in a galvanic element preferably has a total thickness of between 5 μm and 100 μm, particularly preferably of between 10 μm and 35 μm.

The electrodes of a galvanic element and the separator generally form a stable composite. They may, for example, be connected to each other by lamination or adhesive bonding.

Particularly preferably, the positive electrode, the negative electrode and the separator lying in between take the form of a flat, wound or pleated composite. In the first case, the composite comprising the positive electrode, the negative electrode and the separator forms a single cell, while a galvanic element may also contain more than one such cell. The cells may, for example, be arranged in the manner of a stack within a galvanic element. Otherwise, it is of course possible for the galvanic element to be a wound cell or a pleated cell. In this case, the composite preferably has a sequence electrode-separator-electrode-separator.

It is preferred that at least one of the electrodes of a galvanic element is a lithium-intercalating electrode. The galvanic element is correspondingly preferably a primary or secondary lithium battery.

As already mentioned at the beginning, a separator itself is also covered. The separator is intended for use in galvanic elements, in particular those such as are described above. The features described below may correspondingly also serve in particular for characterizing more specifically the separator of the galvanic element. Conversely, the statements made above concerning preferred forms of the separator in a galvanic element (for example, concerning the preferred thickness or concerning the porosity) also apply in principle to the separator described below.

The separator is a multi-layer separator. It always comprises at least one layer of a polymer with a melting and/or softening temperature >200° C. and at least one further layer of a polymer with a melting and/or softening temperature <200° C.

The at least one layer of the higher melting polymer is preferably a thin film. The at least one further layer of the lower melting polymer may likewise be a film, which has, for example, been formed together with the first layer by coextrusion. Alternatively, however, the further layer may also be a coating that has been applied subsequently to a film of the polymer with a melting and/or softening temperature >200° C.

Both the polymer with the melting and/or softening temperature >200° C. (the higher melting polymer) and the polymer with the melting and/or softening temperature <200° C. (the lower melting polymer) have already been defined. Reference is hereby made to the corresponding statements.

A separator preferably has the following layer structure:
a first outer layer of a polymer with a melting and/or softening temperature <200° C.;
a middle layer of a polymer with a melting and/or softening temperature >200° C.; and
optionally, a second outer layer of a polymer with a melting and/or softening temperature <200° C.
   An example of this would be the layer sequence PE/PEEK/PE.

Further features are evident from the example. In this respect, individual features can in each case be realized by themselves or in combination with one another. The preferred forms described merely serve for explanation and better understanding and are not in any way to be understood as restrictive.

### EXAMPLES

(1) 25 kg of PEEK granules with a volume flow rate to ISO 1133 (at 380° C./5 kg) of 70 cm³/10 min to 160 cm³/10 min and 10 kg of a mineral process oil were extruded in a twin-screw extruder with a slit die and calendered to a thickness of 50 μm in a heated rolling unit arranged downstream of the die. The resultant film was completely extracted with hexane at room temperature.

The completely extracted separator was biaxially stretched (monoaxial stretching is also possible) by in each case about 35% (stretching by 20 to 100% of the original length or possibly width is usual) in a tensile stretching machine. The extracted and stretched separator had a porosity of about 45% by volume.

(2) Oven tests with a cell voltage of 4.2 V were carried out with lithium-ion cells in two configurations. Specifications such as UL1642, GB/T 18287 (Chinese Standard for Lithium Batteries) prescribe these. The cells were thereby exposed to a temperature of about 150° C. for more than 10 minutes. In one case, a conventional cell with a polyolefin separator was subjected to the test (reference) and in another case a cell with a separator of PEEK, produced as described under (1), was tested.

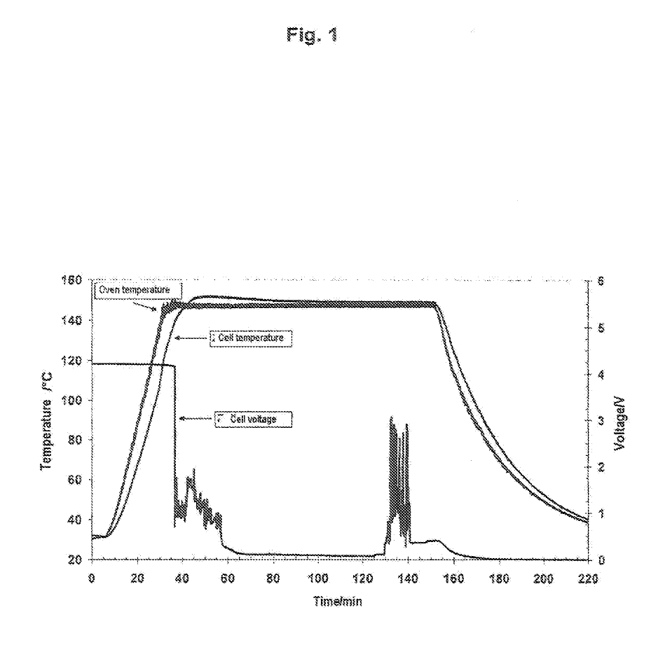

FIG. 1 shows the oven test with the conventional cell, in which severe drops in the cell voltage indicate that there was no longer a safe separation of the electrodes. The cell could have ignited at any time on account of a strong internal short-circuit.

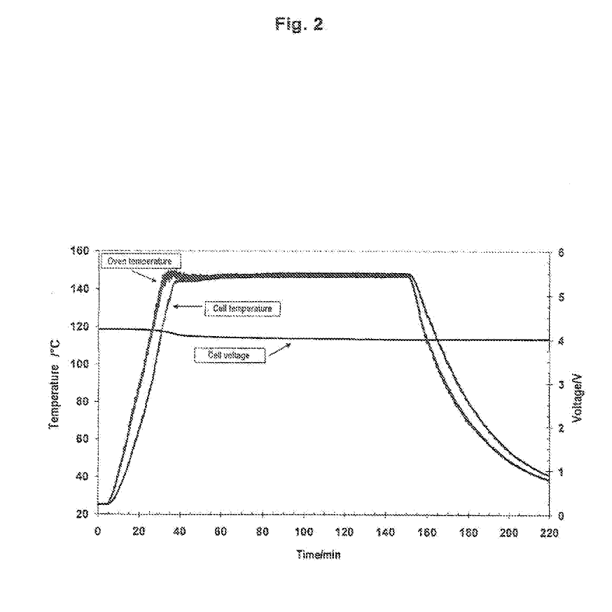

FIG. 2 shows the oven test with our cell (with a PEEK separator) in which the only small decrease in cell voltage demonstrates that there was a safe separation of the electrodes throughout the entire course of the test.

1. A galvanic element comprising: a positive electrode, a negative electrode and a separator consisting at least partially of a polymer of which melting and/or softening temperature is >200° C. in between the positive and negative electrodes.

2. The galvanic element as claimed in claim 1, wherein the melting and/or softening temperature is 200° C. to 400° C.

3. The galvanic element as claimed in claim 1, wherein the polymer with the melting and/or softening temperature >200° C. is a polyether ketone (PEK).

4. The galvanic element as claimed in claim 1, wherein the separator is a single-layer film which consists at least partially of the polymer with the melting and/or softening temperature >200° C.

5. The galvanic element as claimed in claim 1, wherein the separator is a multi-layer film having at least one layer of the polymer with a melting and/or softening temperature >200° C.

6. The galvanic element as claimed in claim 5, wherein the separator comprises at least one layer of a polymer which has a melting and/or softening temperature <200° C.

7. The galvanic element as claimed in claim 6, wherein the polymer with the melting and/or softening temperature <200° C. is a polyolefin.

8. The galvanic element as claimed in claim 1, in the form of a flat, wound or pleated composite.

9. The galvanic element as claimed in claim 1, wherein at least one of the electrodes is a lithium-intercalating electrode.

10. A multi-layer separator for galvanic elements comprising at least one layer of a polymer with a melting and/or softening temperature >200° C. and at least one further layer of a polymer with a melting and/or softening temperature <200° C.

11. The separator as claimed in claim 10, wherein the layer of the polymer with the melting and/or softening temperature >200° C., has a porosity of between 15 and 85%.

12. The separator as claimed in claim 10, wherein the layer of the polymer with the melting and/or softening temperature <200° C. has a porosity of between 15 and 85%.

13. The separator as claimed in claim 10, having a thickness of between 5 μm and 100 μm.

14. The galvanic element as claimed in claim 2, wherein the polymer with the melting and/or softening temperature >200° C. is a polyether ketone (PEK).

15. The separator as claimed in claim 11, wherein the layer of the polymer with the melting and/or softening temperature <200° C. has a porosity of between 15 and 85%.

16. The separator as claimed in claim 11, having a thickness of between 5 μm and 100 μm.

17. The separator as claimed in claim 12, having a thickness of between 5 μm and 100 μm.
